(19) United States
(12) Patent Application Publication
(10) Pub. No.: US 2023/0147338 A1
(43) Pub. Date: May 11, 2023

(54) MOVING IMAGE EDITING DEVICE, MOVING IMAGE EDITING METHOD, AND MOVING IMAGE EDITING PROGRAM

(71) Applicant: FANUC CORPORATION, Minamitsuru-gun, Yamanashi (JP)

(72) Inventors: Sumire OKUAKI, Yamanashi (JP); Shouichi KAWAKAMI, Yamanashi (JP); Yuji TUBOGUCHI, Yamanashi (JP); Yuusuke MATSUDAIRA, Yamanashi (JP); Michitaka MOCHIDA, Yamanashi (JP)

(21) Appl. No.: 17/915,339

(22) PCT Filed: Jun. 22, 2021
(86) PCT No.: PCT/JP2021/023625

§ 371 Date: Sep. 28, 2022

(30) Foreign Application Priority Data
Jun. 29, 2020 (JP) 2020-111212

(51) Int. Cl. G11B 27/02; G06F 3/04845; G06F 3/04847

(52) U.S. Cl. CPC G11B 27/02; G06F 3/04845; G06F 3/04847; G09B 5/02

(57) ABSTRACT

A moving image editing device comprises: a moving image library in which a plurality of moving images are stored; a moving image addition unit that adds one moving image selected by a user from among the plurality of moving images stored in the moving image library to a moving image editing region in which it is possible to play back a moving image displayed on a display unit; a moving image association unit that associates another moving image from the moving image library, for which playback is to be started next, with an indicated component displayed in the moving image editing region in a form enabling the indicated component to be selected by the user when playing back the one moving image; and an associated moving image registration unit that collects and stores, in a storage region, the plurality of moving images associated by the moving image association unit.

### TECHNICAL FIELD

The present invention relates to a moving image editing device, a moving image editing method, and a moving image editing program.

### BACKGROUND ART

Conventionally, in a factory or similar facilities, various types of equipment, for example, devices and machines such as a machine tool and an industrial machine including an industrial robot or the like have been installed. In the factory or similar facilities, workers operate the equipment, to manufacture products, articles, etc. Under current circumstances, the workers receive on-the-job training directly from a veteran worker and refers to an operation manual or the like of the equipment so as to learn how to operate the equipment. In many cases, a factory or similar facilities has production lines as combinations of a plurality of types of equipment. The combinations of the plurality of types of equipment vary from one production line to another.

In addition, each piece of equipment may be customized, for example. However, an operation manual is provided for each piece of equipment, and an additional manual may be provided for such customized equipment. In view of the circumstances described above, there is a demand for a method for a worker to efficiently learn a skill for operating equipment.

A moving image browsing device including a moving image input unit that inputs a moving image and registers the moving image in a database, a scene icon editing unit that extracts respective feature amounts of scenes in the registered moving image, a scene name assignment unit that assigns a scene name for each of the scenes and associates the scene name for each of the scenes, a descriptive information registration unit that associates descriptive information described for the moving image with the moving image, and an extraction unit that extracts an associated moving image associated with the moving image based on at least the scene name and the descriptive information from the database (see Japanese Unexamined Patent Application, Publication No. 2019-179452), for example, has been known as one for acquiring a skill.
Patent Document 1: Japanese Unexamined Patent Application, Publication No. 2019-179452

### DISCLOSURE OF THE INVENTION

### Problems to be Solved by the Invention

Although the above-described technique is related to a moving image of surgical operation, for example, it is considered to be useful to employ a moving image as a tool for learning a technique so as to allow a worker to grasp a series of flows related to handling of equipment. Accordingly, there is a demand for a mechanism capable of easily editing and creating a moving image that can be used for a worker to learn a technique for using various types of equipment, for example, devices and machines such as an industrial machine.

### Means for Solving the Problems

(1) An aspect of the present disclosure is directed to a moving image editing device including a moving image library that stores a plurality of moving images, a moving image addition unit that adds one moving image selected by a user from among the plurality of moving images stored in the moving image library to a moving image editing region allowing reproduction of a moving image displayed on a display unit, a moving image association unit that associates, in the moving image editing region, a designated component to be displayed in a form selectable by the user when the one moving image is reproduced, with another moving image that is stored in the moving image library and is to be subsequently reproduced, and an associated moving image registration unit that collects and stores, in a storage region, the plurality of moving images associated by the moving image association unit.

(2) An aspect of the present disclosure is directed to a moving image editing method performable by a computer including a moving image library that stores a plurality of moving images. The method includes a moving image addition step of adding one moving image selected by a user from among the plurality of moving images stored in the moving image library to a moving image editing region allowing reproduction of a moving image displayed on a display unit of the computer, a moving image association step of associating, in the moving image editing region, a designated component to be displayed in a form selectable by the user when the one moving image is reproduced, with another moving image that is stored in the moving image library and is to be subsequently reproduced, and an associated moving image registration step of collecting and storing, in a storage region, the plurality of moving images associated in the moving image association step.

(3) An aspect of the present disclosure is directed to a moving image editing program causing a computer including a moving image library storing a plurality of moving images to perform steps that include a moving image addition step of adding one moving image selected by a user from among the plurality of moving images stored in the moving image library to a moving image editing region allowing reproduction of a moving image displayed on a display unit of the computer, a moving image association step of associating, in the moving image editing region, a designated component to be displayed in a form selectable by the user when the one moving image is reproduced, with another moving image that is stored in the moving image library and is to be subsequently reproduced, and an associated moving image registration step of collecting and storing, in a storage region, the plurality of moving images associated in the moving image association step.

### Effects of the Invention

According to the one aspect, there can be provided a moving image editing device, a moving image editing method, and a moving image editing program in which a moving image relating to a method for using various types of equipment, for example, devices and machines such as an industrial machine can be simply edited and created.

### BRIEF DESCRIPTION OF THE DRAWINGS

FIG. 1 is a functional block diagram of a moving image editing device according to an embodiment;

FIG. 2 is a diagram for describing a moving image editing screen of the moving image editing device according to the embodiment;

FIG. 3 is a flowchart showing moving image editing processing performed by the moving image editing device according to the embodiment;

FIG. 4 is a diagram showing an example of an operation via the moving image editing screen of the moving image editing device according to the embodiment;

FIG. 5 is a diagram showing an example of an operation via the moving image editing screen of the moving image editing device according to the embodiment;

FIG. 6 is a diagram showing an example of an operation via the moving image editing screen of the moving image editing device according to the embodiment;

FIG. 7 is a diagram showing an example of an operation via the moving image editing screen of the moving image editing device according to the embodiment;

FIG. 8 is a diagram showing an example of an operation via the moving image editing screen of the moving image editing device according to the embodiment;

FIG. 9 is a diagram showing an example of an operation via the moving image editing screen of the moving image editing device according to the embodiment;

FIG. 10 is a diagram showing an example of an operation via the moving image editing screen of the moving image editing device according to the embodiment;

FIG. 11 is a diagram showing an example of an operation via the moving image editing screen of the moving image editing device according to the embodiment;

FIG. 12 is a diagram showing an example of an operation via the moving image editing screen of the moving image editing device according to the embodiment; and

FIG. 13 is a diagram showing an example of an associatory graphic displayed on the moving image editing screen of the moving image editing device according to the embodiment.

### PREFERRED MODE FOR CARRYING OUT THE INVENTION EMBODIMENT

First, an outline of an embodiment of an aspect will be described. The present embodiment relates to performing editing for associating a plurality of moving images and generating a collection of moving images obtained by collecting the plurality of edited moving images. The present embodiment will be described with reference to an example in which moving images representing a procedure for replacement of a fan motor of a machine tool are edited and created.

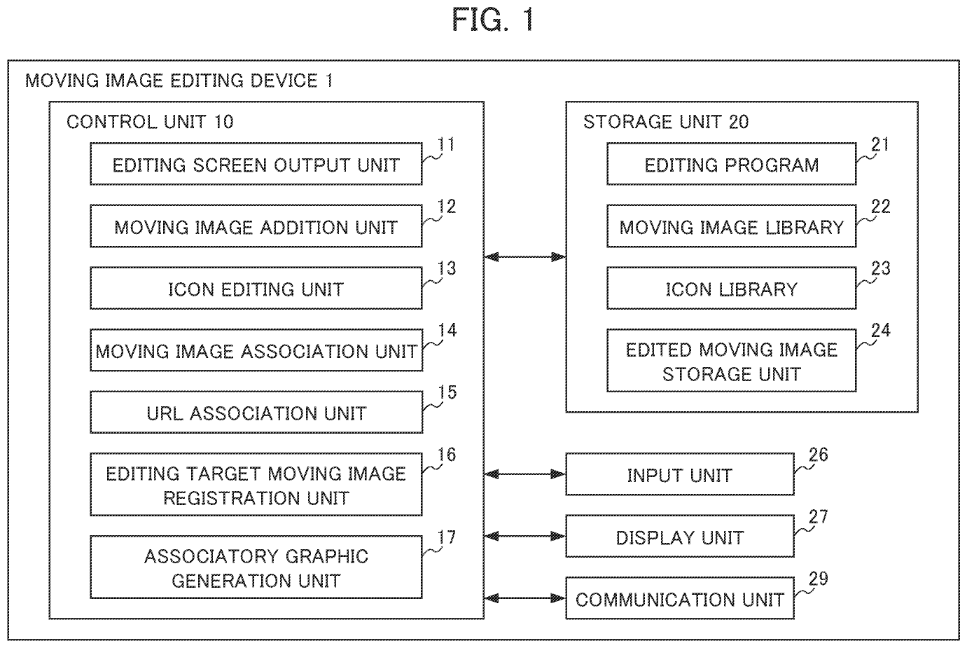

A moving image editing device 1 shown in FIG. 1 is a device for editing moving images. The moving image editing device 1 is an information processing device such as a personal computer (PC), a tablet terminal, or a smartphone. The moving image editing device 1 includes a control unit 10, a storage unit 20, an input unit 26, a display unit 27, and a communication unit 29. The control unit 10 may be a CPU (central processing unit), and performs overall control of the moving image editing device 1 by executing various types of programs for controlling the moving image editing device 1 stored in the storage unit 20.

Before a description of each of functional units in the control unit 10, the storage unit 20 will be described. The storage unit 20 is a storage region that stores programs and the like to be executed by the control unit 10. The storage unit 20 includes an editing program 21, a moving image library 22, an icon library 23, and an edited moving image storage unit 24 (a storage region). The editing program 21 is a program for executing various types of functions of the control unit 10, which will be described later.

The moving image library 22 is a storage region that stores a plurality of moving images. The moving images to be stored in the moving image library 22 can be used to explain how to operate various types of equipment, examples of which include devices and machines such as a machine tool, an industrial machine, and an industrial robot to be handled in a factory or similar facilities. Each of the moving images has a length of, for example, several seconds to several ten seconds. For example, each of the moving images is related to, and prepared for, one type of equipment on a one-to-one basis. Each of the moving images to be stored in the moving image library 22 may be a moving image in an MP4 format, for example. The moving image library may be stored in a server (including a virtual server or the like on a cloud). In this case, the moving image editing device 1 may acquire a moving image by accessing the server.

The icon library 23 is a storage region that stores a plurality of icons each representing an instruction item. The icon may be a stamp, for example, and may be one represented by an intuitive picture. Examples of the icon include ones respectively represented by pictures of arrows indicating “return” and “next”, one represented by a picture of a house indicating “return to start”, and ones respectively including letters “YES” and “NO”. Further, there may be a plurality of icons having the same pictorial pattern but in different colors. Providing icons having the same content (picture) but in various colors allows an editor who creates a moving image (hereinafter referred to also as the user) to select one or more icons having a color that is considered to be appropriate, depending on the background color of a location where the icon is to be inserted.

The edited moving image storage unit 24 is a storage region that stores a plurality of moving images being edited by the moving image editing device 1 and a collection of moving images obtained by collecting the plurality of moving images. The icon library and the edited moving image storage unit may be stored in a server (including a virtual server or the like on a cloud). In this case, the moving image editing device 1 may acquire the icon by accessing the server. The moving image editing device 1 may store the plurality of moving images being edited and the collection of moving images by accessing the server.

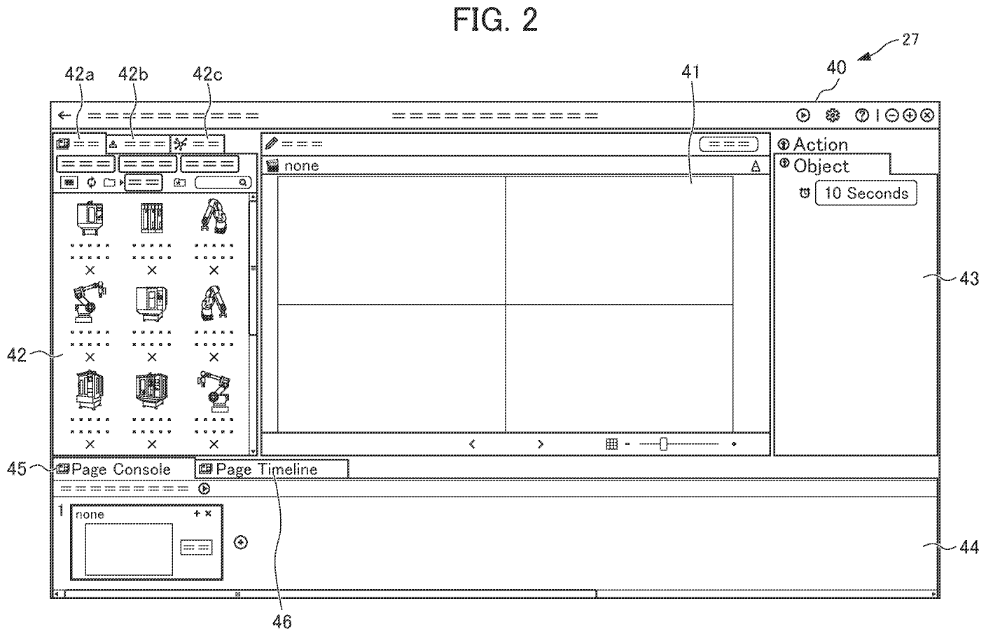

The control unit 10 includes an editing screen output unit 11, a moving image addition unit 12, an icon editing unit 13 (an icon setting display unit), a moving image association unit 14, a URL association unit 15 (a URL designation receiving unit), an editing target moving image registration unit 16 (an associated moving image registration unit and a moving image collection generation unit), and an associatory graphic generation unit 17. The editing screen output unit 11 outputs to the display unit 27 a moving image editing screen including a canvas region (a moving image editing region) that allows reproduction of a moving image. The moving image editing screen will be described with reference to FIG. 2.

The moving image editing screen 40 shown in FIG. 2 is a screen for use to generate a collection of moving images obtained by associating a plurality of moving images. The moving image editing screen 40 includes a canvas region 41, an icon region 42, a branch setting region 43, and a switchable display region 44. The canvas region 41 is a main editing screen for use to edit a moving image. When the user performs an operation for adding a moving image to be edited to the canvas region 41, the moving image in a reproducible state is outputted to the canvas region 41. The user can then perform various types of editing on the moving image outputted to the canvas region 41.

The icon region 42 is a region where an icon that can be added to the moving image to be edited is displayed. The icon region 42 displays content in a switchable manner by means of a thumbnail tab 42a, a stamp tab 42b, and a branch tab 42c. With the thumbnail tab 42a selected, a list of thumbnail images as images each representing one scene of a moving image is displayed on the icon region 42, for example. With the stamp tab 42b selected, a list of a plurality of icons stored in the icon library 23 is displayed on the icon region 42, for example. With the branch tab 42c selected, an associatory graphic representing association of moving images is displayed on the icon region 42.

The branch setting region 43 is a region where association is to be set. The branch setting region 43 allows association to be performed by way of setting a moving image to be reproduced subsequent to the moving image displayed on the canvas region 41. The branch setting region 43 allows association to be performed by way of designating an external URL (uniform resource locator) or the like representing an external web page from the moving image displayed on the canvas region 41.

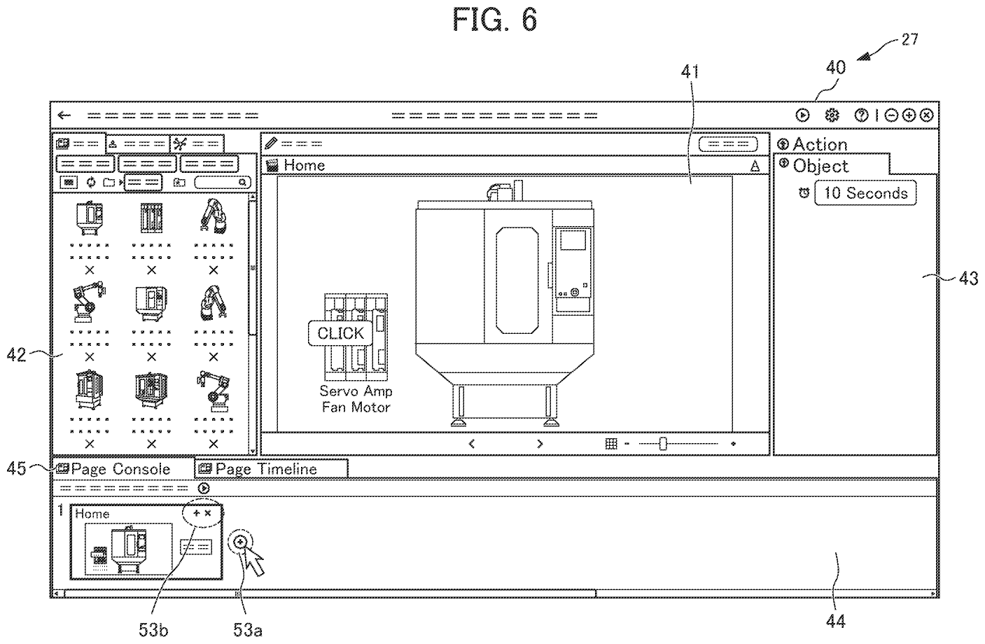

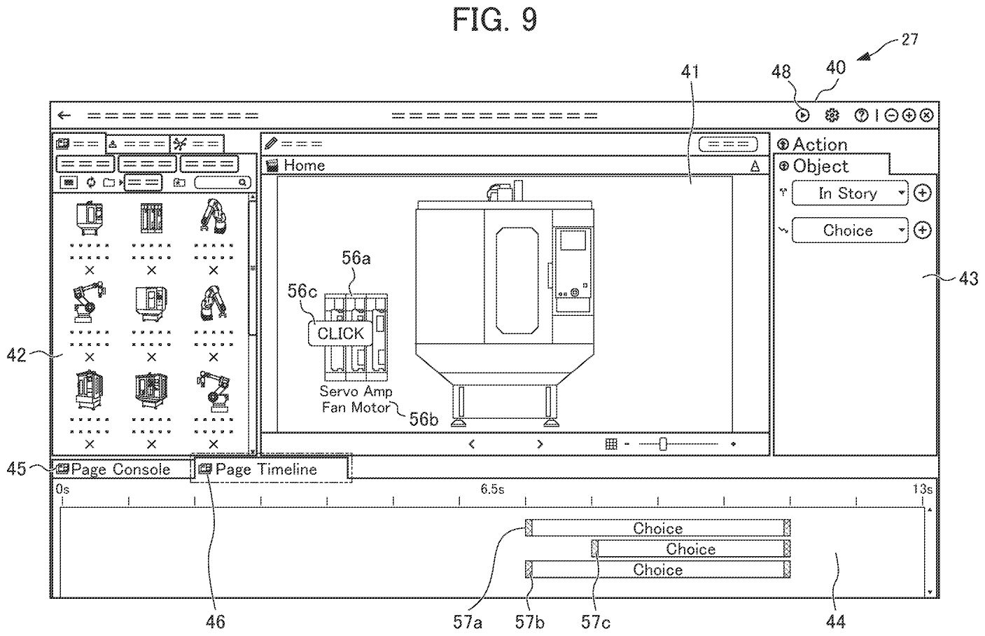

The switchable display region 44 is a region on which a page console 45 and a page timeline 46 (an icon display setting region) are displayed in a switchable manner. As shown in FIGS. 6, 7, and 8 to be described later, the page console 45 indicates, as one page, an editing target moving image including a moving image added to the canvas region 41 and displays edited pages to be subjected to collection processing target side by side. As shown in FIG. 9 to be described later, the page timeline 46 is used to set a display timing and a display time period at and during which an icon set in a moving image in the canvas region 41 is displayed when the moving image is reproduced. A specific method for editing a moving image using the moving image editing screen 40 will be described later.

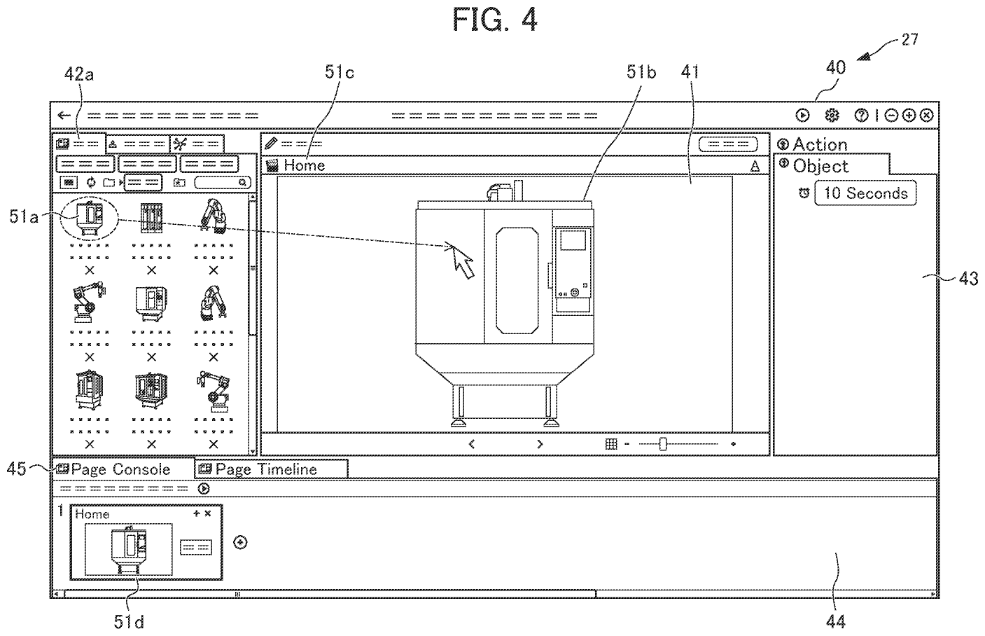

As shown in FIG. 4 to be described later, the moving image addition unit 12 shown in FIG. 1 adds one moving image selected by a user from among the plurality of moving images stored in the moving image library 22 to the canvas region 41. More specifically, the user selects one of the thumbnail images displayed in a list on the icon region 42 with the thumbnail tab 42a (see FIG. 2) selected, and drags the selected thumbnail image to the canvas region 41. As a result, the moving image addition unit 12 can add a moving image corresponding to the selected thumbnail image to the canvas region 41.

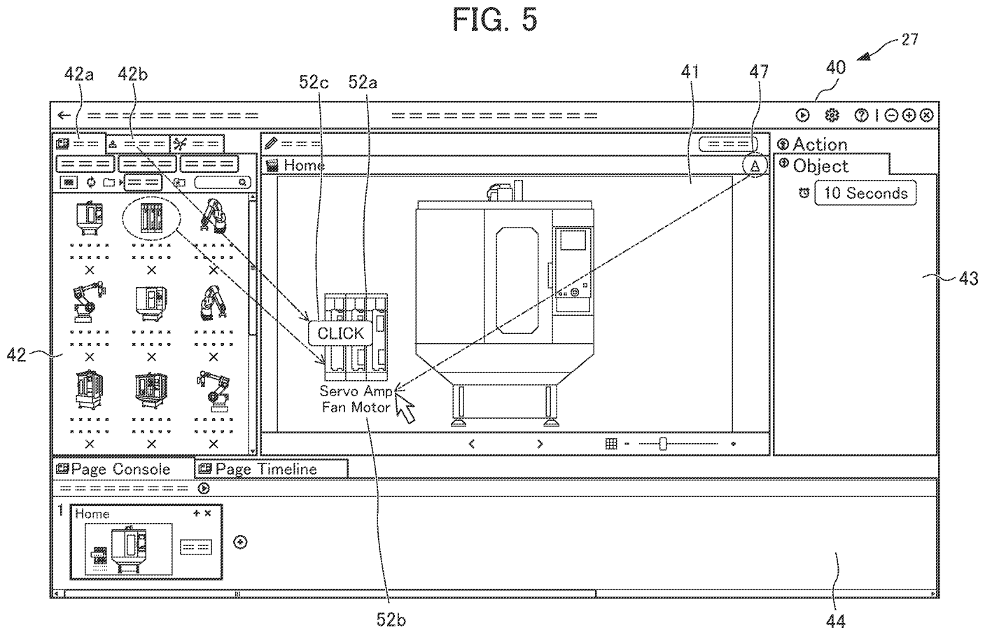

As shown in FIG. 5 to be described later, the icon editing unit 13 adds an icon (designated component) selected by the user from the icon library 23 to a position in the canvas region 41 designated by the user, in the moving image added by the moving image addition unit 12. More specifically, the user selects one of the icons displayed in a list on the icon region 42 with the stamp tab 42b (see FIG. 2) selected, and drags the selected icon to the canvas region 41. As a result, the icon editing unit 13 can add the selected icon to an operation position in the canvas region 41.

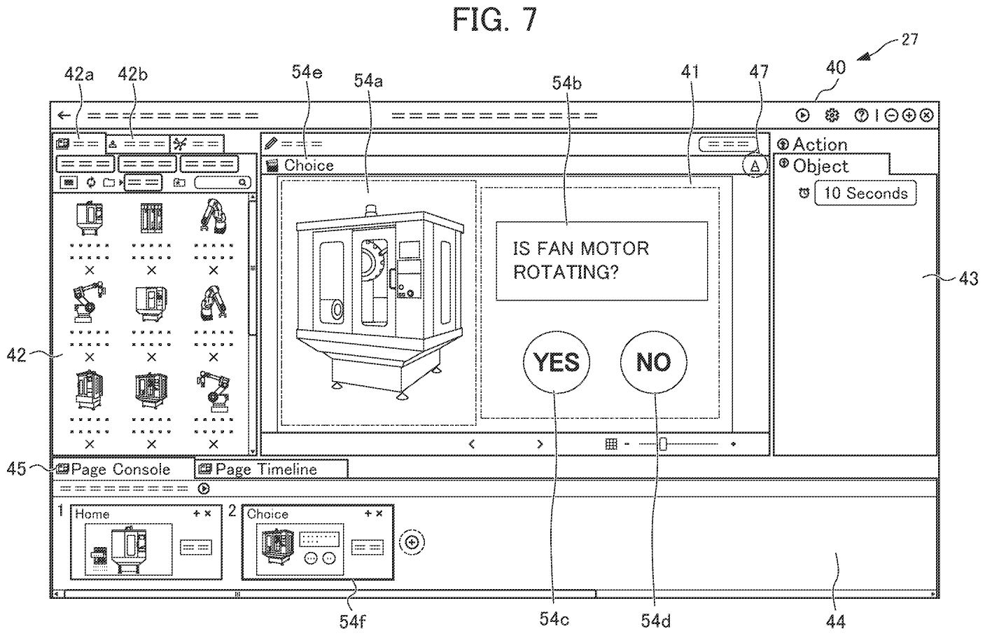

Icons that can be added by the icon editing unit 13 are not limited to the icons stored in the icon library 23. The icon may be replaced with a rectangular region into which a text can be inputted, for example, a text box, as shown in FIGS. 5 and 7 to be described later. The icon editing unit 13 may add a thumbnail image corresponding to the moving image stored in the moving image library 22. The icon editing unit 13 allows for setting a display timing and a display time period of an icon by switching the switchable display region 44 to the page timeline 46 and displaying the page timeline 46, as shown in FIG. 9 to be described later.

The moving image association unit 14 allows, by means of the branch setting region 43, the icon or the like added by the icon editing unit 13 to be associated with another moving image that is stored in the moving image library 22 and is to be subsequently reproduced, at the time of reproduction of the moving image added to the canvas region 41. The URL association unit 15 receives an external URL representing an external web page to be designated by the user in the branch setting region 43. The URL association unit 15 allows, by means of the branch setting region 43, the icon or the like added by the icon editing unit 13 to be associated with the received external URL at the time of reproduction of the moving image added to the canvas region 41.

The editing target moving image registration unit 16 stores, in the edited moving image storage unit 24, a plurality of moving images associated by the moving image association unit 14. The editing target moving image registration unit 16 generates a collection of moving images obtained by collecting the plurality of moving images stored in the edited moving image storage unit 24, and stores the generated collection of moving images in the edited moving image storage unit 24. The editing target moving image registration unit 16 can create one folder in the edited moving image storage unit 24 and collects and stores the moving images in the folder. The editing target moving image registration unit 16 can generate a collection of moving images having a file configuration conforming to an HTML5 format, for example.

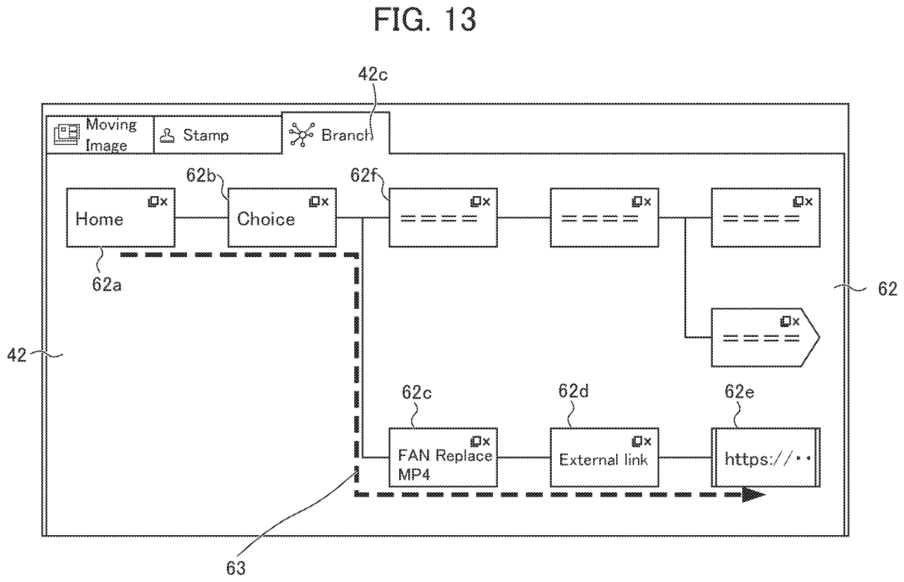

The associatory graphic generation unit 17 generates an associatory graphic including objects respectively representing the plurality of moving images collected and stored in the edited moving image storage unit 24 by the editing target moving image registration unit 16 and association among the objects, as shown in FIG. 13 to be described later. More specifically, when the user selects the branch tab 42c (see FIG. 2), the associatory graphic generation unit 17 outputs the generated associatory graphic to the icon region 42.

Examples of the input unit 26 include input devices such as a keyboard, a mouse, and various types of buttons such as a switch button. The display unit 27 is a display device, and is configured by a CRT (cathode ray tube) or an LCD (liquid crystal display), for example. A touch panel functioning as both the input unit 26 and the display unit 27 may be provided. The communication unit 29 is an interface that communicates with an external device (a Web server, etc.).

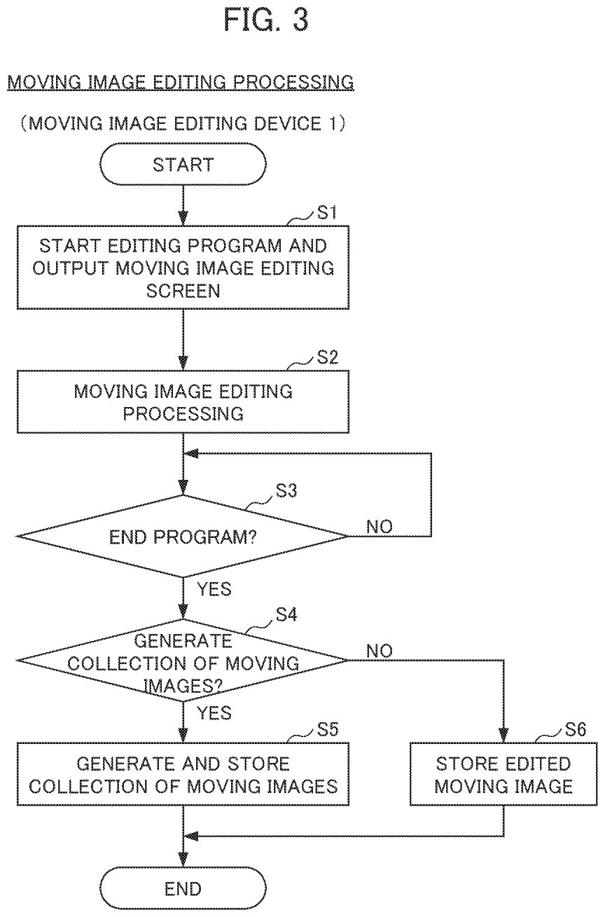

A procedure relating to creation of a collection of moving images using the moving image editing device 1 according to the present embodiment will be described next. FIG. 3 is a flowchart relating to moving image editing processing performed by the moving image editing device 1. In Step S1 (“Step S” is hereinafter merely referred to as “S”) shown in FIG. 3, in response to the user selecting an icon indicating the editing program 21 displayed on the display unit 27, for example, the control unit 10 in the moving image editing device 1 starts the editing program 21 in the storage unit 20. The control unit 10 (the editing screen output unit 11) outputs the moving image editing screen 40 (see FIG. 2) to the display unit 27. In S2, the control unit 10 performs moving image editing processing.

The moving image editing processing is now described with reference to specific examples. As shown in FIG. 4, the user first creates “1. Home” as a top page. When the user designates the thumbnail tab 42a, the control unit 10 switches the icon region 42 to a thumbnail list. Next, as described above, the user drags a thumbnail image 51a displayed on the icon region 42 to the canvas region 41 in order to edit the first moving image. As a result, the control unit 10 (the moving image addition unit 12) can add a moving image 51b represented by the thumbnail image 51a to the canvas region 41. The moving image 51b represents a mounting position from a front surface of a machine tool. The user changes the name “51c” of a page as an editing target moving image including the moving image 51b to be edited via the canvas region 41 to “Home”. Further, as described above, the page console 45 in the switchable display region 44 displays a page 51d including the moving image 51b shown on the canvas region 41. The page 51d is indicated within a thick frame that indicates a state where the image is being outputted to the canvas region 41.

Then, the user performs an operation for adding an icon. As shown in FIG. 5, in response to the user sequentially selecting and dragging three designated components including icons displayed in the icon region 42, the control unit 10 (the icon editing unit 13) additionally displays the three designated components on positions at dragging destinations on the canvas region 41. This example relates to replacement of a fan in an amplifier. In the example shown in FIG. 5, a thumbnail image 52a as an amplifier image, a text 52b for indicating the type of amplifier, and a stamp 52c “CLICK” having a button shape for clicking are added to the canvas region 41. A text box is added to a position where it is desired to be inserted on the canvas region 41 with the text addition button 47 selected, for example, by dragging the text box on the canvas region 41. The text 52b can be generated by the user inputting a text into the added text box. After the thumbnail image 52a and the stamp 52c are additionally displayed on the canvas region 41, their respective positions and sizes can be appropriately changed.

Then, “2. Choice” as a page of a moving image to be reproduced is created. As shown in FIG. 6, the user brings the switchable display region 44 into a state where the page console 45 is displayed thereon and selects an addition button 53a on the right of a page “Home” in the page console 45. Accordingly, the control unit 10 outputs a new page similar to that shown in FIG. 2 to the canvas region 41, although the new page is not shown. Even if the user selects a “+” button in the page operation button 53b provided on the page “Home” in the page console 45, a new page can be similarly added. When the user selects an “x” button in the page operation button 53b provided on the page “Home” in the page console 45, the page can be deleted.

In FIG. 7, a moving image to be reproduced subsequent to “Home” is added to the added new canvas region 41, and a designated component is further added thereto. When the user performs an operation described with reference to FIGS. 4 and 5 above, the canvas region 41 is brought into a state shown in FIG. 7. When the user first designates the thumbnail tab 42a displayed on the icon region 42, as described above, the control unit 10 switches the icon region 42 to a thumbnail list. The user then drags a corresponding thumbnail image onto the canvas region 41. As a result, the control unit 10 (the moving image addition unit 12) additionally displays the moving image 54a on the canvas region 41.

Next, as described above with reference to FIG. 5, when the user drags a text box to a position where the text box is to be inserted on the canvas region 41 with the text addition button 47 located at an upper right portion of the canvas region 41 selected, the text box is added to the position. In response to the user inputting a text into the added text box, the control unit 10 (the icon editing unit 13) generates a text 54b. When the user designates a stamp tab 42b, the control unit 10 switches the icon region 42 to an icon list. When the user drags predetermined icons outputted to the icon list onto the canvas region 41, the control unit 10 (the icon editing unit 13) additionally displays stamps 54c and 54d respectively corresponding to the predetermined icons on positions at dragging operation destinations. The example shown in FIG. 7 is creation of a diagnosis screen, the text 54b is a question sentence “Is fan motor rotating?”, and the stamps 54c and 54d are respectively “Yes” and “No” as options of an answer to a question.

Further, the user edits the name “54e” of the moving image 54a to be edited in the canvas region 41 into “Choice”. As a result, the page console 45 in the switchable display region 44 displays a page 54f in the canvas region 41 is indicated within a thick frame that indicates a selected state.

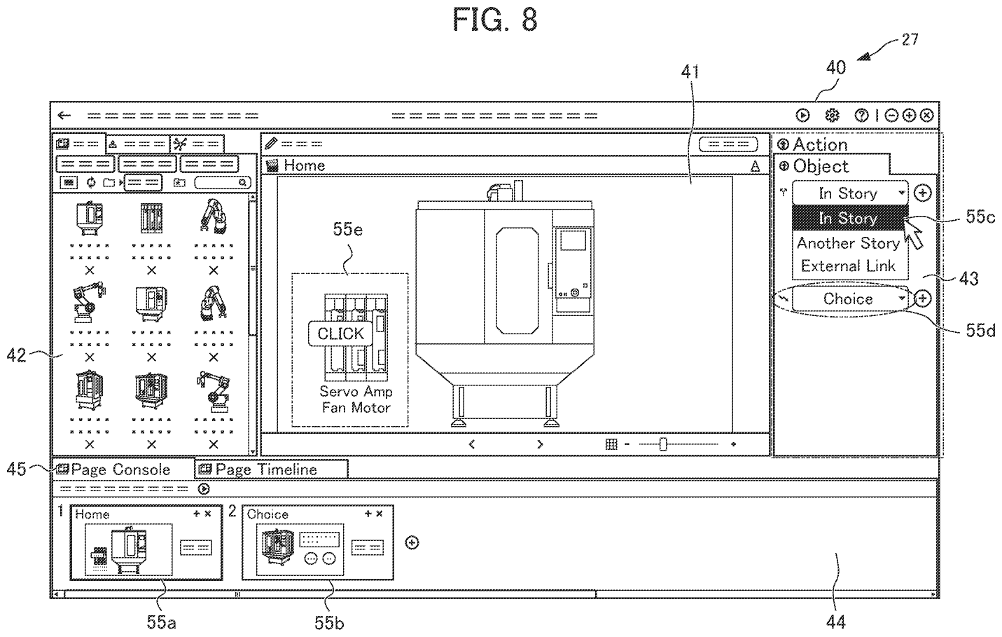

Next, two editing target moving images “Home” and “Choice” are associated with each other. As shown in FIG. 8, when the user selects a page 55a from the page console 45 in switchable display region 44, the canvas region 41 is brought into a state where the moving image “1. Home” is displayed thereon again. The user selects a region 55e on the canvas region 41 such that three designated components added onto the canvas region 41 are included therein. Thereafter, the user selects “in story” from a drop down list 55c displayed on the branch setting region 43 and designates “Choice”, which is indicated in a page 55b, in an association destination designation column 55d displayed on the branch setting region 43. The association destination designation column 55d can display a created page outputted to the page console 45 and a page being created, in selectable manner. Accordingly, the control unit 10 (the moving image association unit 14) can associate the page 55a with the page 55b by means of the designated components in the region 55e on the canvas region 41.

As shown in FIG. 9, the user can set a display timing and a display time period at and during which each of the designated components is displayed by selecting the page timeline 46 and switching the switchable display region 44, as described above. Upon the user operating bars 57a to 57c, shown in the page timeline 46 respectively corresponding to designated components 56a to 56c in the canvas region 41, the control unit 10 (the icon editing unit 13) can set the display timing and the display time period at and during which each of the designated components 56a to 56c is displayed. Specifically, the user can change the display time period by selecting any one of the bars 57a to 57c and moving its ends to the right or left. The user can change the display timing by selecting any one of the bars 57a to 57c and moving its center to the right or left.

Upon the user selecting a reproduction button 48, the control unit 10 reproduces and displays the moving image generated by way of the above-described operation of the canvas region 41. The user can adjust the display timing and the display time period of each of the designated components 56a to 56c while checking its reproduced state. In particular, a timing for transitioning to the subsequent moving image should be after the currently-reproduced moving image is viewed to the end. Therefore, the respective display timings at which the designated components 56a to 56c are displayed are desirably not immediately after the start of reproduction of the moving image but after a certain length of the moving image is reproduced. Although all the designated components transition to “Choice” in the case of the example shown in FIG. 9, the designated components may be associated with different moving images.

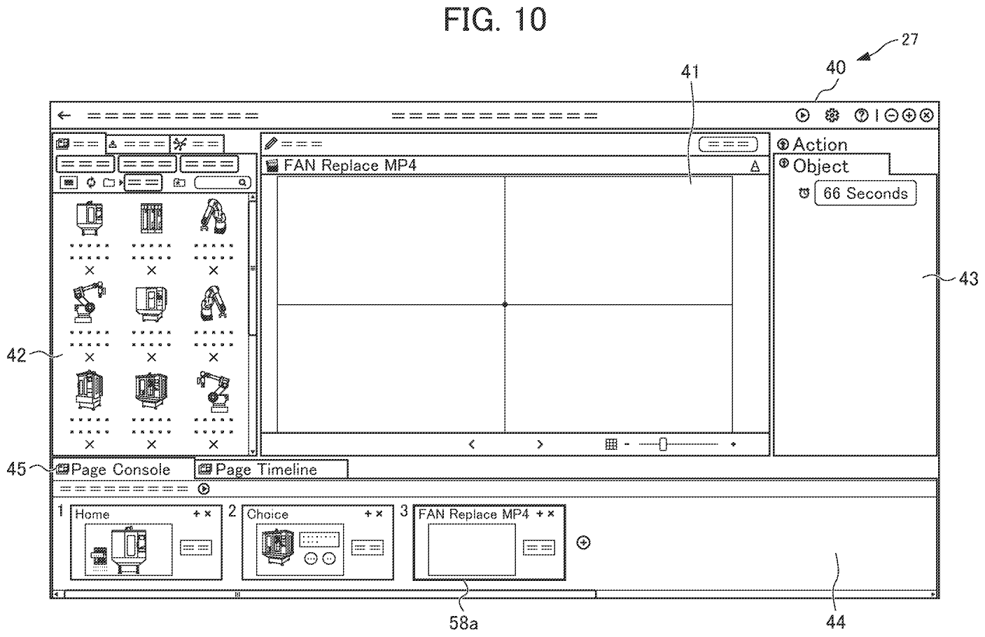

Next, FIG. 10 shows an operation screen for creating a page of a moving image to be reproduced subsequent to “2. Choice”. In this case, the user can display a new page on the canvas region 41 by performing an operation similar to the operation for adding a new page, as described with reference to FIG. 6. As a result, the page console 45 in the switchable display region 44 s brought into a state where a page 58a is added thereto and designated. In the above-described manner, the user edits the canvas region 41.

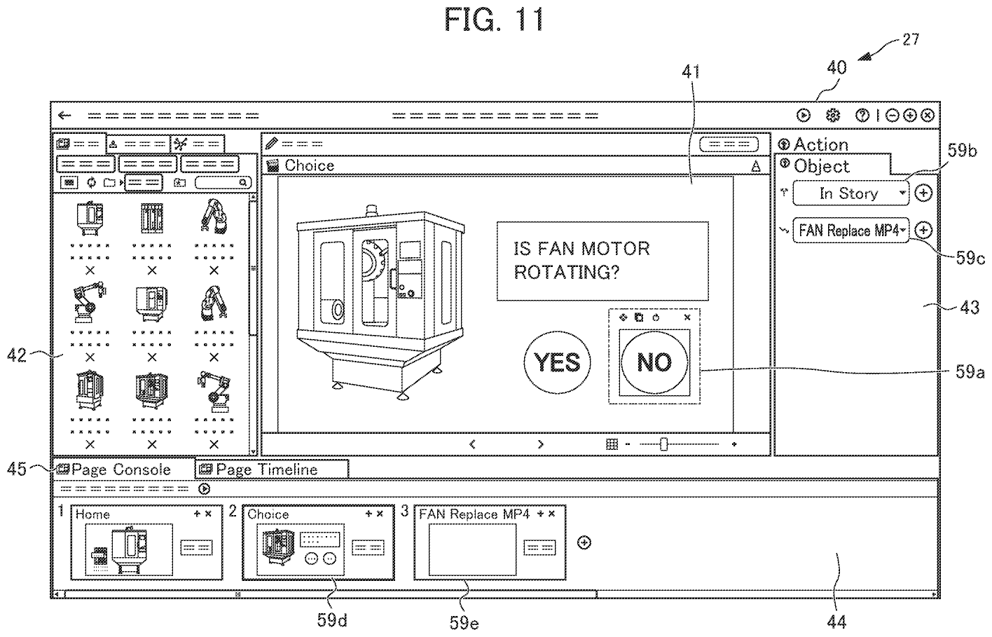

FIG. 11 shows an operation screen for associating a moving image to be reproduced subsequently, with a stamp 59a of “2. Choice”. If a stamp “Yes” is selected, for example, the fan motor is rotating. Thus, a moving image for a scenario for inquiring whether a current value is equal to or less than a reference value is associated therewith (not shown). On the other hand, when a stamp 59a “No” is selected, for example, the fan motor is not rotating. Accordingly, a moving image for a scenario in which the fan motor needs to be replaced is associated therewith. The user selects a region including the stamp 59a, and then operates the branch setting region 43 to select “in story” from a drop down list 59b and designate a page indicated ted by a page 59e in an association destination designation column 59c. As a result, the control unit 10 (the moving image association unit 14) can associate the pages 59d and 59e with each other by means of the stamp 59a to make the page 59d transition to the page 59e.

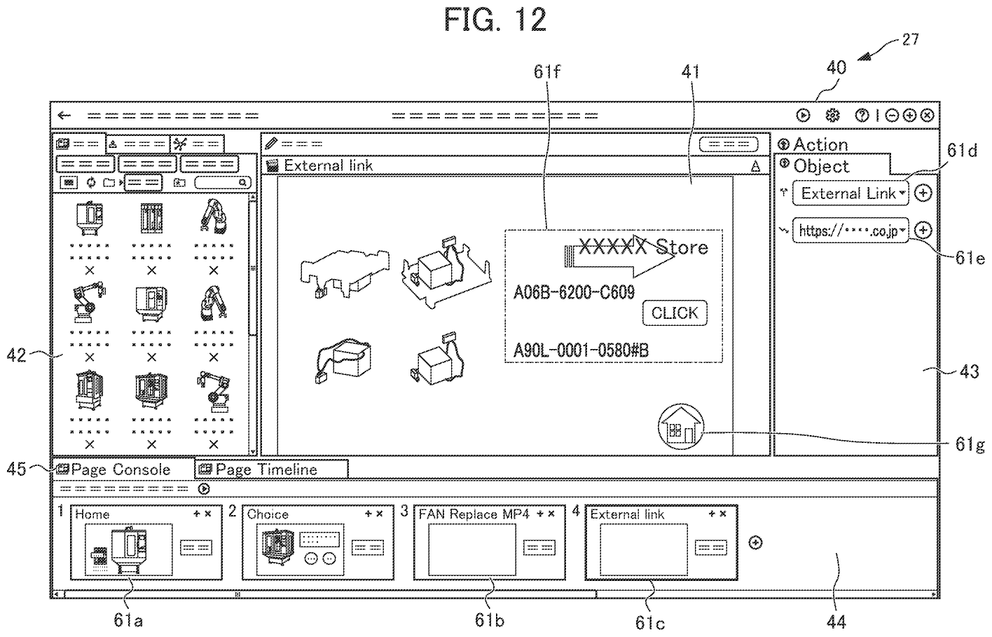

FIG. 12 shows a moving image editing screen 40 on which a page 61c associated with a page 61b is being edited. The moving image represented by the page 61c relates to replacement of an amplifier fan motor. The user selects a region 61f including designated components. Thereafter, the user operates the branch setting region 43 to select an “external link” from a drop down list 61d, and designates a URL of a component sales site where the component displayed on the moving image can be purchased by, for example, manually inputting, the URL into an association destination designation column 61e. As a result, the control unit 10 (the URL association unit 15) can associate the external URL such that a transition from the page 61c to a web page represented by the external URL is possible. That is, the moving image editing device 1 can easily associate the external URL by each of the designated components included in the region 61f.

The user selects a stamp 61g, and then operates the branch setting region 43. The user selects “in story” from the drop down list 61d and designates “Home” indicated by the page 61a, in the association destination designation column 61e so that the control unit 10 (the moving image association unit 14) can associate the page 61c and the page 61a with each other by means of a designated component in the stamp 61g.

The moving images associated with each other by way of the above-described method can be displayed in a summarized manner in an associatory graphic. Specifically, when the branch tab 42c (see FIG. 2) is selected with the moving image editing screen 40 displayed, the control unit 10 (the associatory graphic generation unit 17) generates an associatory graphic 62 shown in FIG. 13, and outputs the generated associatory graphic 62 to the icon region 42. The “Home” described with reference to FIGS. 4 to 6 above is represented by an object 62a, and the “Choice” described with reference to FIG. 7 is represented by an object 62b. As described with reference to FIGS. 11 and 12, objects 62c to 62e are indicated in association with one another. The association of the pages described in the above-described examples is indicated by an arrow 63. In the example shown in FIG. 11, a page corresponding to an object 62f is associated with the stamp “YES”.

Thus, the user can edit moving images by way of a series of simple operations via the input unit 26 by referring to the moving image editing screen 40, and can easily associate the plurality of moving images in accordance with designation by the user.

In S3 shown in FIG. 3, the control unit 10 receives an operation for finishing the editing program 21 by the user, to determine whether to finish the editing program 21, for example. If the editing program 21 is to be finished (YES in S3), the control unit 10 causes the processing to proceed to S4. On the other hand, if the editing program 21 is not to be finished (NO in S3), the control unit 10 causes the processing to proceed to S2, to continue the moving image editing processing.

In S4, the control unit 10 determines whether to generate a collection of moving images. The control unit 10 determines that the collection of moving images is to be generated in response to receiving the user's selection of an output button (not shown) upon completion of moving image editing, for example. If the collection of moving images is to be generated (YES in S4), the control unit 10 causes the processing to proceed to S5. On the other hand, if the collection of moving images is not to be generated (No in S4), the control unit 10 causes the processing to proceed to S6. A case where the collection of moving images is not generated corresponds to a case where the moving images are being created.

In S5, the control unit 10 (the editing target moving image registration unit 16) generates the collection of moving images, and stores the generated collection of moving images in the edited moving image storage unit 24. The control unit 10 generates an HTML file, for example, as the collection of moving images. Then, the control unit 10 causes the processing to end. On the other hand, in S6, the control unit 10 (the editing target moving image registration unit 16) stores the plurality of edited moving images in the edited moving image storage unit 24. When the plurality of moving images being edited are collected and stored in the edited moving image storage unit 24, a dedicated folder may be generated, assigned with a folder name, and stored. As a result, the editing processing can be resumed by calling the folder name. Then, the control unit 10 causes the processing to end.

As described above, the user is allowed to easily edit and create moving images that can be used for a worker using various types of equipment, for example, devices and machines such as an industrial machine to learn a technique. Further, a collection of moving images created by way of this operation is stored in one folder whereby the collection of moving images can be easily copied on another computer or the like. Accordingly, workers in factories or similar facilities can appropriately obtain necessary information while seeing the collection of moving images. Accordingly, even an inexperienced worker can perform work without a mistake if he/she follows an instruction provided by such an interactive collection of moving images.

A program used in the present embodiment can be stored using various types of non-transitory computer readable media and supplied to a computer. The non-transitory computer readable media include various types of tangible storage media. Examples of the non-transitory computer readable medium include a magnetic recording medium (e.g., a flexible disk, a magnetic tape, or a hard disk drive), a magneto-optical recording medium (e.g., a magneto-optical disk), a CD-ROM (read only memory), a CD-R, a CD-R/W, a semiconductor memory (e.g., a mask ROM, a PROM (programmable ROM), an EPROM (erasable PROM), a flash ROM, and a RAM (random access memory)). The program may be supplied to a computer by various types of transitory computer readable media. Examples of the transitory computer readable medium include an electric signal, an optical signal, and an electromagnetic wave. The transitory computer readable medium can supply the program to the computer via a wired communication path such as an electrical wire and an optical fiber or a wireless communication path.

Although the above-described embodiment is one of preferred embodiments of the present invention, the scope of the present invention is not limited to only the above-described embodiment, and the present invention can be implemented in various ways with diverse modifications made without departing from the spirit of the present invention.

### (Modification 1)

Although the moving image editing device 1 in which the control unit 10 has various types of functions and the storage unit 20 stores various types of data has been described as an example in the above-described embodiment, the present invention is not limited to this. The moving image editing device 1 may have a configuration of a distributed system. For example, the functions of the moving image editing device 1 and some or all of data and the like stored in the storage unit 20 may be provided in a different device that can communicate via a network and a virtual server produced on a cloud, and these devices as the whole may perform the functions of the moving image editing device 1.

### (Modification 2)

Although the moving image editing device 1 that creates the moving image related to “replacement of fan motor” has been described as an example in the above-described embodiment, the present invention is not limited to this. A different moving image may be edited and created, provided that the moving image is an interactive know-how moving image as a collection of moving images associated with each other. For example, it is possible to edit and create a moving image for a state checking, a mounting position guidance, an operation explanation, a removal procedure, or an assembly procedure.

### (Modification 3)

Although the moving image editing device 1 using the previously-provided icons has been described as an example in the above-described embodiment, the present invention is not limited to this. If an icon created by a user himself/herself is registered in the icon storage unit, the icon can be used as a user-original icon. The size of the icon can be changed as desired by selecting the icon on the canvas region and enlarging and reducing the frame of the icon.

### (Modification 4)

Although the moving image editing screen has been described as an example in the above-described embodiment, a configuration of the moving image editing screen is not limited to this. A different screen configuration may be adapted provided that various types of processing (e.g., association of moving images, association with an external URL, addition of an icon, and setting of a display timing and a display time period of an icon) corresponding to the above-described operations by the user can be performed.

### (Modification 5)

Although display in the Japanese language has been described in the above-described embodiment, the present invention is not limited to this. Display corresponding to a plurality of languages such as English and Chinese may be prepared, and the presence or absence of caption can be selected. As a result, a collection of moving images can be used in various countries.

As described above, according to the present embodiment, the following function and effect, for example, are obtained.

(1) The moving image editing device 1 includes: the moving image library 22 that stores a plurality of moving images; the moving image addition unit 12 that adds one moving image selected by a user from among the plurality of moving images stored in the moving image library 22, to a canvas region 41 allowing reproduction of a moving image displayed on a display unit 27; the moving image association unit 14 that associates, in the canvas region 41, a designated component to be displayed in a form selectable by the user when the one moving image is reproduced, with another moving image that is stored in the moving image library 22 and is to be subsequently reproduced; and the editing target moving image registration unit 16 that collects and stores, in an edited moving image storage unit 24, the plurality of moving images associated by the moving image association unit 14.

As a result, the moving image editing device 1 can generate an interactive know-how moving image as one collection of moving images. The moving image editing device 1 can associate the designated component with the subsequent moving image by the user. Specifically, in response to a viewer selecting the designated component, a moving image in a flowchart format can be generated which allows the subsequent moving image to be reproduced.

(2) The moving image editing device 1 described in (1) may include the associatory graphic generation unit 17 that generates the associatory graphic 62 containing objects respectively representing the plurality of moving images collected and stored in the edited moving image storage unit 24 by the editing target moving image registration unit 16 and association among the objects. As a result, the moving image editing device 1 can provide to the user the association of the plurality of moving images in the form of the associatory graphic, thereby allowing the user to visually check the entire flow of editing target moving images when editing the moving images.

(3) The moving image editing device 1 described in (1) or (2) may include: the icon library 23 that stores a plurality of icons each representing an instruction item; and the icon editing unit 13 that adds, as the designated component, the icon selected by the user from the icon library 23 to a position of the canvas region 41 designated by the user in the one moving image added by the moving image addition unit 12. The editing target moving image registration unit 16 may store, in the edited moving image storage unit 24, a moving image to which the icon has been added by the icon editing unit 13. As a result, the user can use the icon registered in the icon library 23 by way of a simple operation, and can easily generate a moving image including options, for example.

(4) In the moving image editing device 1 described in (3), the icon editing unit 13 may display the page timeline 46 for setting a display timing and a display time period at and during which the icon added is displayed while the one moving image is reproduced. As a result, the moving image editing device 1 can arbitrarily set the display timing and the display time period in the moving image of the icon, and can create a moving image convenient for use.

(5) The moving image editing device 1 described in any one of (1) to (4) may include the URL association unit 15 that receives designation of an external URL representing an external web page and associates the received external URL with the designated component displayed on the canvas region 41 in response to an operation by the user. As a result, in response to the user selecting the designated component displayed in the moving image, the external web page can be displayed. For example, if a URL of a component sales site where the component displayed in the moving image can be purchased is designated as the external URL, the user can be guided to purchase a component without a mistake.

(6) In the moving image editing device 1 described in any one of (1) to (5), the editing target moving image registration unit 16 may generate a collection of moving images obtained by collecting the plurality of moving images stored in the edited moving image storage unit 24. As a result, the collection of moving images can be placed in one folder and can be copied in a folder unit, for example. Accordingly, maintenance and transfer of the moving images can be easily performed.

(7) A moving image editing method performable by the moving image editing device 1 including the moving image library 22 that stores a plurality of moving images includes: a moving image addition step of adding one moving image selected by a user from among the plurality of moving images stored in the moving image library 22 to a canvas region 41 allowing reproduction of a moving image displayed on a display unit 27 of the moving image editing device 1; a moving image association step of associating, in the canvas region 41, a designated component to be displayed in a form selectable by the user when the one moving image is reproduced, with another moving image that is stored in the moving image library 22 and is to be subsequently reproduced; and an associated moving image registration step of collecting and storing, in an edited moving image storage unit 24, the plurality of moving images associated in the moving image association step. As a result, a similar effect to that in (1) can be obtained.

(8) The editing program 21 causes the moving image editing device 1 including the moving image library 22 storing a plurality of moving images to perform steps that include a moving image addition step of adding one moving image selected by a user from among the plurality of moving images stored in the moving image library 22 to a canvas region 41 allowing reproduction of a moving image displayed on a display unit 27 of the moving image editing device 1; a moving image association step of associating, in the canvas region 41, a designated component to be displayed in a form selectable by the user when the one moving image is reproduced, with another moving image that is stored in the moving image library 22 and is to be subsequently reproduced; and an associated moving image registration step of collecting and storing, in an edited moving image storage unit 24, the plurality of moving images associated in the moving image association step. As a result, a similar effect to that in (1) can be obtained.

### EXPLANATION OF REFERENCE NUMERALS

1: Moving image editing device
10: Control unit
11: Editing screen output unit
12: Moving image addition unit
13: Icon editing unit
14: Moving image association unit
15: URL association unit
16: Editing target moving image registration unit
17: Associatory graphic generation unit
20: Storage unit
21: Editing program
22: Moving image library
23: Icon library
24: Edited moving image storage unit
26: Input unit
27: Display unit
41: Canvas region
46: Page timeline
62: Associatory graphic

1. A moving image editing device comprising:
a moving image library that stores a plurality of moving images;
a moving image addition unit that adds one moving image selected by a user from among the plurality of moving images stored in the moving image library to a moving image editing region allowing reproduction of a moving image displayed on a display unit;
a moving image association unit that associates, in the moving image editing region, a designated component to be displayed in a form selectable by the user when the one moving image is reproduced, with another moving image that is stored in the moving image library and is to be subsequently reproduced; and
an associated moving image registration unit that collects and stores, in a storage region, the plurality of moving images associated by the moving image association unit.

2. The moving image editing device according to claim 1, further comprising:
an associatory graphic generation unit that generates an associatory graphic containing objects respectively representing the plurality of moving images collected and stored in the storage region by the associated moving image registration unit and association among the objects.

3. The moving image editing device according to claim 1, further comprising:
an icon library that stores a plurality of icons each representing an instruction item, and
an icon editing unit that adds, as the designated component, the icon selected by the user from the icon library to a position of the moving image editing region designated by the user in the one moving image added by the moving image addition unit,
wherein the associated moving image registration unit stores, in the storage region, a moving image to which the icon has been added by the icon editing unit.

4. The moving image editing device according to claim 3, further comprising:
an icon setting display unit that displays an icon display setting region for setting a display timing and a display time period at and during which the icon added by the icon editing unit is displayed while the one moving image is being reproduced.

5. The moving image editing device according to claim 1, further comprising:
a URL designation receiving unit that receives designation of an external URL representing an external web page, and
a URL association unit that associates the external URL received by the URL designation receiving unit with the designated component displayed in the moving image editing region in response to an operation by the user.

6. The moving image editing device according to claim 1, further comprising:
a moving image collection generation unit that generates a collection of moving images obtained by collecting the plurality of moving images stored in the storage region by the associated moving image registration unit.

7. A moving image editing method performable by a computer comprising a moving image library that stores a plurality of moving images, the method comprising:
a moving image addition step of adding one moving image selected by a user from among the plurality of moving images stored in the moving image library to a moving image editing region allowing reproduction of a moving image displayed on a display unit of the computer can be reproduced;
a moving image association step of associating, in the moving image editing region, a designated component to be displayed in a form selectable by the user when the one moving image is reproduced, with another moving image that is stored in the moving image library and is to be subsequently reproduced; and
an associated moving image registration step of collecting and storing, in a storage region, the plurality of moving images associated in the moving image association step.

8. A non-transitory computer readable medium configured to store a moving image editing program for causing a computer comprising a moving image library storing a plurality of moving images to perform steps that comprise:
a moving image addition step of adding one moving image selected by a user from among the plurality of moving images stored in the moving image library to a moving image editing region allowing reproduction of a moving image displayed on a display unit of the computer;
a moving image association step of associating, in the moving image editing region, a designated component to be displayed in a form selectable by the user when the one moving image is reproduced, with another moving image that is stored in the moving image library and is to be subsequently reproduced; and
an associated moving image registration step of collecting and storing, in a storage region, the plurality of moving images associated in the moving image association step.
